(19) United States
(12) Patent Application Publication
(10) Pub. No.: US 2022/0219851 A1
(43) Pub. Date: Jul. 14, 2022

(54) INFLATABLE WEB MATERIALS AND RAILS FOR GUIDING THE SAME

(71) Applicant: Sealed Air Corporation (US), Charlotte, NC (US)

(72) Inventors: Bradley K. Powell, Rock Hill, SC (US); Garrett P. Dyer, Charlotte, NC (US)

(21) Appl. No.: 17/609,844

(22) PCT Filed: May 8, 2020
(86) PCT No.: PCT/US2020/031981

§ 371 Date: Nov. 9, 2021

Related U.S. Application Data
(60) Provisional application No. 62/845,354, filed on May 9, 2019.

(51) Int. Cl. B65B 41/16; B31D 5/00; B65B 55/20; B65B 5/04

(52) U.S. Cl. CPC B65B 41/16; B31D 5/0073; B31D 2205/0058; B65B 5/045; B31D 2205/0047; B65B 55/20

(57) ABSTRACT

An automated packaging station is configured to inflate and seal a web material. The automated packaging station includes a rail, a nozzle, and a sealing system. The web material includes a channel that is closed so that the channel can be slid over the rail. The nozzle inserts gas into the channel of the web material, which is in fluid communication with chambers to inflate the chambers. The sealing system seals closed ends the chambers proximate the channel after inflation of the chambers. A shape of the rail causes the channel and an opposite longitudinal side of the web material to diverge either before or during inflation of the chambers by the nozzle.

### BACKGROUND

The present disclosure is in the technical field of automated formation of inflated packages. More particularly, the present disclosure is directed to web materials that have multiple channels and rails for guiding the web materials during inflation and sealing of inflatable chambers in the web materials.

Consumers frequently purchase goods from mail-order or internet retailers, which package and ship the goods to the purchasing consumer via a postal service or other carrier. Millions of such packages are shipped each day. These items are normally packaged in small containers, such as boxes or envelopes. To protect the items during shipment, they are typically packaged with some form of protective dunnage that may be wrapped around the item or stuffed into the container to prevent movement of the item and to protect it from shock.

Common types of mailing envelope are sometimes referred to as “mailers.” In some cases, these mailers have cushioning to provide some level of protection for the objects transported therein. The outer walls of cushioned mailers are typically formed from protective materials, such as Kraft paper, cardstock, polyethylene-coated paper, other paper-based materials, polyethylene film, or other resilient materials. The inner walls of cushioned mailers are lined with cushioning materials, such as air cellular material (e.g., BUBBLE WRAP™ air cellular material sold by Sealed Air Corporation), foam sheets, or any other cushioning material. The outer walls are typically adhered (e.g., laminated) to the cushioning material when forming the mailers.

When goods are shipped in rigid containers, such as corrugated cardboard boxes, dunnage material is typically added to the containers to take up some of the void space within the containers. Inflated cushions, pillows, or other inflated containers are common void fill materials that are either placed loose in a container with an object or wrapped around an object that is then placed in a container. The cushions protect the packaged item by absorbing impacts that may otherwise be fully transmitted to the packaged item during transit, and also restrict movement of the packaged item within the carton to further reduce the likelihood of damage to the item. Another common form of void fill material is paper, such as Kraft paper, that has been folded or crumped into a low-density, three-dimensional pad or wad that is capable of filling void space without adding significant weight to the container.

It would be advantageous to automate the packaging process to minimize the amount of time required to package objects properly. However, given the wide variety of ways which objects can be packaged for shipping, automation of the packaging process can be challenging.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In a first embodiment, an automated packaging station is configured to inflate and seal a web material. The automated packaging station includes a first rail, a first nozzle, and a first sealing system. The web material includes a first channel and the first channel is closed so that the first channel can be slid over the first rail. The first nozzle is configured to insert gas into the first channel of the web material. The first channel is in fluid communication with chambers of the web material so that the gas inserted into the first channel can pass into the chambers to inflate the chambers. The first sealing system is configured to seal closed ends the chambers proximate the first channel after inflation of the chambers. A shape of the first rail is configured to cause the first channel and an opposite longitudinal side of the web material to diverge either before or during inflation of the chambers by the first nozzle.

In a second embodiment, the first nozzle of the first embodiment includes one or more first outlets. The first rail is a hollow tube through which the gas passes before the gas passes through the one or more first outlets and into the first channel.

In a third embodiment, a leading end of the first rail of the second embodiment is closed and a trailing end of the first rail is couplable to a source of pressurized gas.

In a fourth embodiment, the automated packaging station of the third embodiment further includes a second rail and a second nozzle. The web material includes a second channel and the second channel is closed so that the second channel can be slid over the second rail. The second nozzle is configured to insert gas into the second channel of the web material. The second nozzle includes one or more second outlets. The second rail is a hollow tube through which the gas passes before the gas passes through the one or more second outlets and into the second channel. A leading end of the second rail is closed and a trailing end of the second rail is couplable to the source of pressurized gas.

In a fifth embodiment, the automated packaging station of any of the previous embodiments further includes a first roller configured to move the first channel along the first rail.

In a sixth embodiment, the automated packaging station of the fifth embodiment is configured such that the first roller includes a first pair of rollers configured to be placed around the first rail.

In a seventh embodiment, each roller in the first pair of rollers of the sixth embodiment has a concave profile around the first rail.

In an eighth embodiment, the opposite longitudinal side of the web material of any of the previous embodiments includes a longitudinal seal that closes the chambers.

In a ninth embodiment, the automated packaging station of any of the previous embodiments further includes a second rail, where the opposite longitudinal side of the web material includes a second channel. The second channel is closed so that the second channel can be slid over the second rail.

In a tenth embodiment, the automated packaging station of the ninth embodiment further includes a second sealing system configured to seal closed ends of the chambers proximate the second channel after inflation of the chambers. Before the second sealing system seals closed the ends of the chambers proximate the second channel, the chambers are in fluid communication with the second channel.

In an eleventh embodiment, the automated packaging station of any of the ninth to tenth embodiments further includes a guide located below the first and second rails. The guide is configured to contact portions of the web material below the first channel and the second channel and to have a biasing effect on the web material that encourages unfolding of a longitudinal fold in the web material.

In a twelfth embodiment, the guide of the eleventh embodiment has longitudinal sides that have a shape similar to the shape of the first and second rails.

In a thirteenth embodiment, the automated packaging station of any of the ninth to twelfth embodiments further includes a first cutting mechanism and a second cutting mechanism. The first cutting mechanism is configured to cut the first channel downstream of a location where the first sealing system is configured to seal closed the ends of the chambers proximate the first channel. The second cutting mechanism is configured to cut the second channel downstream of the location where the second sealing system is configured to seal closed the ends of the chambers proximate the second channel.

In a fourteenth embodiment, the automated packaging station of any of the ninth to thirteenth embodiments further includes a support structure. Leading ends of the first and second rails are cantilevered from the support structure so that the first channel can be slid over a leading end of the first rail and the second channel can be slid over a leading end of the second rail.

In a fifteenth embodiment, the automated packaging station of any of the previous embodiments further includes a cutting mechanism configured to cut the first channel downstream of a location where the first sealing system is configured to seal closed the ends of the chambers proximate the first channel.

In a sixteenth embodiment, a web material includes two juxtaposed sheets sealed together to form, a first channel proximate a first longitudinal edge of the web material, a second channel proximate a second longitudinal edge of the web material, and chambers that extend substantially transversely across the web material between the first and second channels. The first channel is in fluid communication with the chambers. The first and second channels are closed so that the first channel is configured to be slid onto a first rail of an automated packaging machine and the second channel is configured to be slid onto a second rail of the automated packaging machine.

In a seventeenth embodiment, the two juxtaposed sheets of the sixteenth embodiment are also sealed together to form ports between the chambers and the first channel.

In a eighteenth embodiment, each of the chambers of any of the sixteenth or seventeenth embodiments has cells that are substantially circular and are interconnected by interconnecting channels that are narrower than the widest point of the cells.

In a nineteenth embodiment, a pair of adjacent chambers of the eighteenth embodiment are offset so that the cells of one of the chambers are aligned with the interconnecting channels of a subsequent one of the chambers.

In a twentieth embodiment, the second channel of any of the sixteenth to nineteenth embodiments is not in fluid communication with the chambers.

In a twenty first embodiment, the two juxtaposed sheets of any of the sixteenth to twentieth embodiments are also sealed together to form a longitudinal seal between the chambers and the second channel.

In a twenty second embodiment, the second channel of any of the sixteenth to nineteenth embodiments or the nineteenth embodiment is in fluid communication with the chambers.

### BRIEF DESCRIPTION OF THE DRAWING

The foregoing aspects and many of the attendant advantages of the disclosed subject matter will become more readily appreciated as the same become better understood by reference to the following detailed description, when taken in conjunction with the accompanying drawings, wherein:

FIG. 1A depicts an example of a web material that can be formed into a pouch for packaging an object, in accordance with embodiments disclosed herein;

FIGS. 1B and 1C depict front and side cross-sectional views, respectively, of an embodiment of the web material shown in FIG. 1A in a folded state before inflation of the chambers, in accordance with embodiments disclosed herein;

FIGS. 2A and 2B depict examples of cross-sections of the web material shown in FIGS. 1B and 1C when the first and second longitudinal edges are held apart from each other, in accordance with embodiments disclosed herein;

FIGS. 2C and 2D depict an example of difficulty in conveying the web material shown in FIGS. 1B and 1C,

FIGS. 3A and 3B depict front and cross-sectional side views, respectively, of a web material in an unfolded state, in accordance with embodiments disclosed herein;

FIGS. 4A, 4B, and 4C depict front, cross-sectional side, and back views, respectively, of the web material shown in FIGS. 3A and 3B in a folded state before inflation of the chambers, in accordance with embodiments disclosed herein;

FIGS. 5A and 5B depict bottom and side views, respectively, of an embodiment of an automated packaging station that uses the web material shown in FIGS. 4A to 4C, in accordance with embodiments disclosed herein;

FIG. 5C depicts a cross-sectional view of an embodiment of rollers around a rail in an automated packaging station, in accordance with embodiments disclosed herein;

FIGS. 6A and 6B depict front and top views, respectively, of an example of loading the web material shown in FIGS. 4A to 4C on the first and second rails of the automated packaging station shown in FIGS. 5A and 5B, in accordance with embodiments disclosed herein;

FIGS. 7A and 7B depict front and cross-sectional side views, respectively, of another embodiment of a web material in an unfolded state, in accordance with embodiments disclosed herein;

FIGS. 8A, 8B, and 8C depict cross-sectional side, and back views, respectively, of the web material shown in FIGS. 7A and 7B in a folded state before inflation of the chambers, in accordance with embodiments disclosed herein;

FIG. 9 depicts a bottom view of another embodiment of an automated packaging station that uses the web material shown in FIGS. 8A to 8C, in accordance with embodiments disclosed herein; and

FIG. 10 depicts a bottom view of an embodiment of automated packaging station that includes a single guide rail, in accordance with embodiments disclosed herein.

### DETAILED DESCRIPTION

The present disclosure describes embodiments of web materials that have multiple channels and rails for guiding the web materials during inflation and sealing of inflatable chambers in the web materials. In some embodiments, a web material is formed from two juxtaposed sheets sealed together. The seals in the sheets form a first channel proximate a first longitudinal edge of the web material, a second channel proximate a second longitudinal edge of the web material, and chambers that extends substantially transversely across the web material between the first and second channels. The first channel is in fluid communication with the chambers. The first and second channels are closed so that the first channel is configured to be slid onto a first rail of an automated packaging machine and the second channel is configured to be slid onto a second rail of the automated packaging machine.

In some embodiments an automated packaging station is configured to inflate and seal a web material. The automated packaging station has two rails. The web material includes two channels that are closed so that each of the channels can be slid over one of the rails. The automated packaging station has a nozzle that inserts gas into one of the channels of the web material, which is in fluid communication with chambers of the web material so that the gas inserted into the channel can pass into the chambers to inflate the chambers. The automated packaging station also includes a sealing system that seals closed ends the chambers proximate the channel after inflation of the chambers. A shape of the first and second rails is configured to cause the first and second channels of the web material to diverge either before or during inflation of the chambers by the first nozzle.

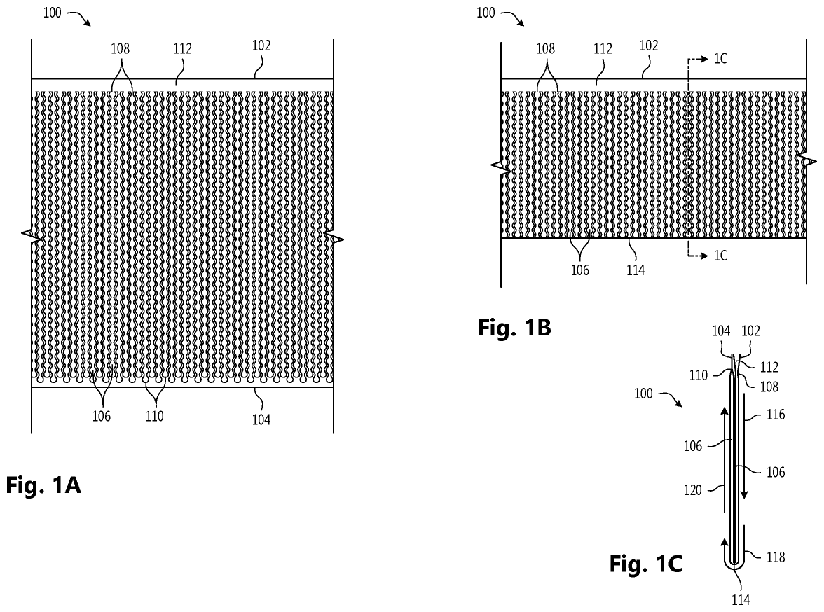

Depicted in FIG. 1A is an example of a web material 100 that can be formed into a pouch for packaging an object. In the depicted embodiment, the web material 100 is an inflatable air cellular material. As used herein, the term “air cellular material” herein refers to bubble cushioning material, such as BUBBLE WRAP® air cushioning material sold by Sealed Air Corporation, where a first film or laminate is formed (e.g., thermoformed, embossed, calendared, or otherwise processed) to define a plurality of cavities and a second film or laminate is adhered to the first film or laminate in order to close the cavities. Examples of air cellular materials are shown in U.S. Pat. Nos. 3,142,599, 3,208,898, 3,285,793, 3,508,992, 3,586,565, 3,616,155, 3,660,189, 4,181,548, 4,184,904, 4,415,398, 4,576,669, 4,579,516, 6,800,162, 6,982,113, 7,018,495, 7,165,375, 7,220,476, 7,223,461, 7,429,304, 7,721,781, and 7,950,433, and U.S. Published Patent Application Nos. 2014/0314978 and 2015/0075114, the disclosures of which are hereby incorporated by reference in their entirety.

As used herein, an “object” may comprise a single item for packaging or grouping of several distinct items where the grouping is to be in a single package. Further, an object may include an accompanying informational item, such as a packing slip, tracking code, a manifest, an invoice, or printed sheet comprising machine-readable information (e.g., a bar code) for sensing by an object reader (e.g., a bar code scanner). In some embodiments, each of the objects includes an object identifier. In some examples, the object identifier includes one or more of a barcode, a quick response (QR) code, a radio frequency identification (RFID) tag, any other form a machine-readable information, human-readable information, or any combination thereof.

The web material 100 includes a first longitudinal edge 102 and a second longitudinal edge 104. Between the first and second longitudinal edges 102 and 104 are two juxtaposed sheets (e.g., sheets of film) that are sealed together to form chambers 106. In the depicted embodiment, the chambers 106 are in an uninflated state and the chambers 106 are capable of being inflated. In the depicted embodiment, each of the chambers 106 extends substantially transversely across the web material 100 and the pattern of the chambers 106 generally repeats in the longitudinal direction.

In the depicted embodiment, each of the chambers 106 includes a port 108 that is open and a distal end 110 that is closed. The ports 108 are located proximate the first longitudinal edge 102 and the distal ends 110 are located proximate the second longitudinal edge 104 so that the ports extend substantially transversely across the web material 100. The juxtaposed sheets are sealed between the ports 108 and the distal ends 110 such that each of the chambers 106 has substantially circular cells that are interconnected by channels that are narrower than the widest point of the cells. The chambers 106 are capable of being inflated by inserting a gas (e.g., air) through the ports 108. Once the chambers 106 are inflated, the cells form three-dimensional shapes (sometimes referred to as “bubbles”) along the inflated chambers 106. In the depicted embodiment, a pair of adjacent chambers 106 are offset so that the cells of one of the chambers 106 are aligned with the interconnecting channels of a subsequent one of the chambers 106.

To aid in inflation of the chambers 106, the web material 100 includes a common channel 112. In the depicted embodiment, the common channel 112 is in fluid communication with the chambers 106. In some embodiments, a nozzle can be inserted in the common channel 112 and direct a gas into the common channel 112. The gas inserted into the common channel 112 can pass through the ports 108 to inflate the chambers 106. In some embodiments, the nozzle may remain fixed while located within the common channel 112 and the web material 100 is moved longitudinally such that the nozzle sequentially inflates the chambers 106. Coupled to the nozzle may be a sealing device configured to close (e.g., seal closed) the ports 108 after inflation of the chambers 106.

In some embodiments, the web material 100 can be folded and formed into a pouch for holding and cushioning an object. In some embodiments, the web material 100 can be folded, inflated, and transversely sealed to form an inflated pouch. An object can be inserted into the pouch and then the pouch can be closed to form a package around the object. Examples of systems and methods of forming a pouch and then a package in this manner are described in U.S. Patent Application No. 62/783,250, the contents of which are hereby incorporated by reference herein by reference in their entirety. In some embodiments, the web material 100 is formed from a material that is suitable for shipping the object. For example, the web material 100 may be opaque.

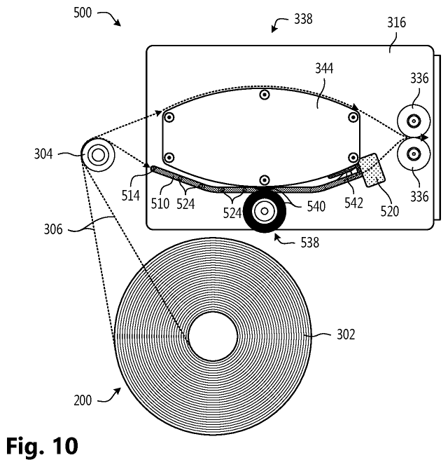

In order to form an inflated pouch, the web material 100 can be folded, inflated, and transversely sealed. Depicted in FIGS. 1B and 10 are front and side cross-sectional views, respectively, of an embodiment of the web material 100 in a folded state before inflation of the chambers 106. A longitudinal fold 114 has been formed in the web material 100. In the depicted embodiment, the longitudinal fold 114 is substantially equidistant from the first and second longitudinal edges 102 and 104. This type of fold is sometimes referred to as a “C fold” because the first and second longitudinal edges 102 and 104 are substantially the same distance away from the longitudinal fold 114, as opposed to a “J fold” when a longitudinal fold is offset from the center of the web material so that the longitudinal edges extend different distances away from the longitudinal fold.

In the folded orientation shown in FIGS. 1B and 10, the web material 100 can be wound onto a supply roll. In some embodiments, the web material 100 can be wound such that the longitudinal edges 102 and 104 are on one side of the roll and the longitudinal fold 114 are on the other side of the roll. To inflate the web material 100, the web material 100 can be unwound from the roll and fed through an inflation and sealing system that inflates and seals the chambers 106 sequentially. In some embodiments, the inflation and sealing system includes a nozzle that can be positioned that that the two sides of the common channel 112 pass over the nozzle as the web material 100 is fed away from the supply roll. In the depicted embodiment, the common channel 112 is an “open” channel because the two sheets are not commented to each other. An open channel allows the two sheets to pass on either side of the nozzle without cutting the channel. In other embodiments, the common channel 112 can be a “closed” channel where the two sheets are connected to each other. A closed channel requires the two sheets to be cut before the sheets can pass on either side of the nozzle.

To inflate the chambers 106, the nozzle can insert gas into common channel 112 so that the gas passes through the ports 108 and into the chambers 106 in a substantially linear direction indicated by an arrow 116. As some of the gas reaches the longitudinal fold 114, the gas passes in the direction indicated by the arrow 116, then around the longitudinal fold 114 as indicated by an arrow 118, and then continues through the chambers 106 toward the distal ends 110 in a direction indicated by the arrow 120. The gas may fill both the portions of the chambers 106 between the longitudinal fold 114 and the distal ends 110 and the portions of the between the longitudinal fold 114 and the ports 108.

When the web material 100 is folded about the longitudinal fold 114 in the configuration shown in FIGS. 1B and 10, the chambers 106 may not consistently inflate properly. As can be seen in FIG. 10, the longitudinal fold 114 can function as a crease in the web material 100 which deters or prevents gas from passing through the chambers 106 at the longitudinal fold 114. In this case, during the time that one of the chambers 106 is exposed to the gas from the nozzle, the longitudinal fold 114 may prevent sufficient gas from passing through the longitudinal fold 114 to fully inflate the chamber. The chambers 106 can thus be under inflated and not provide a desired amount of cushioning. In addition, the arrows 116 and 120 are substantially parallel to each other and in substantially opposite directions. When the gas is inserted into the chambers in the direction indicated by the arrow 116, the sides of the chambers 106 near the longitudinal fold 114 operate to change the direction of the flow of gas. The forces imparted by the gas as it changed directions may be sufficient to cause deformity (e.g., stretching) or failure (e.g., rupture) of the walls of the chambers 106 near the longitudinal fold 114. In the case of deformity of the chambers 106, the resulting package can be aesthetically unpleasing and/or have reduced cushioning properties. In the case of failure of the chambers 106, the resulting package may be rendered unsuitable for protecting and/or shipping an object.

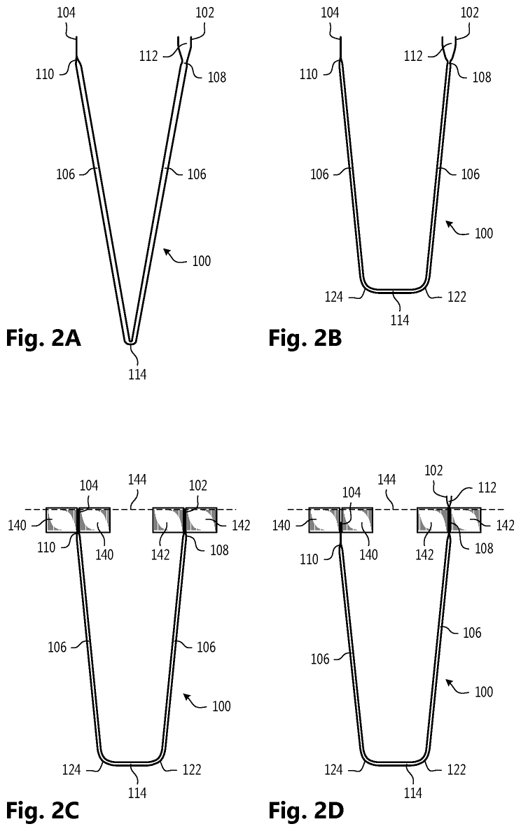

The issues with inflation of the web material 100 in the folded configuration shown in FIGS. 1B and 10 can be improved by holding the first and second longitudinal edges 102 and 104 apart where the chambers 106 are inflated. In some embodiments, an automatic packaging system may hold the first and second longitudinal edges 102 and 104 apart from each other during inflation. Depicted in FIG. 2A is an example of a cross section of the web material 100 when the first and second longitudinal edges 102 and 104 are held apart from each other. In the depicted embodiment, the cross-section of the web material 100 is substantially V-shaped. In the depicted embodiment, the portion of the chambers 106 on one side of the longitudinal fold 114 and the portion of the chambers 106 on the other side of the longitudinal fold 114 are at an angle with respect to each other. The angle is greater than 0° such that the portion of the chambers 106 on one side of the longitudinal fold 114 is not parallel to the portion of the chambers 106 on the other side of the longitudinal fold 114.

To inflate the chambers 106, an inflation nozzle can insert gas into the common channel 112 so that the gas passes through the ports 108 and into the chambers 106. As some of the gas reaches the longitudinal fold 114, the gas passes around the longitudinal fold 114, and then continues through the chambers 106 toward the distal ends 110. The gas may fill both the portions of the chambers 106 between the longitudinal fold 114 and the distal ends 110 and the portions of the between the longitudinal fold 114 and the ports 108.

When the web material 100 is in the orientation shown in FIG. 2B, the longitudinal fold 114 may not completely close off the chambers 106 at the longitudinal fold 114. This may allow at least some gas to pass through the chambers 106 at the longitudinal fold 114. In some embodiments, the orientation of the longitudinal fold 114 may permit each of the chambers 106 to permit sufficient gas to pass by the longitudinal fold 114 during the time that each of the chambers 106 is exposed to the gas from an inflation nozzle to fully inflate the chambers 106. In addition, the forces imparted by the gas at the longitudinal fold 114 may not be sufficient to cause deformity or failure of the walls of the chambers 106 near the longitudinal fold 114. However, in some embodiments, the first and second longitudinal edges 102 and 104 may not be positioned far enough apart so that the angle is large enough to permit sufficient gas to pass by the longitudinal fold 114 during the time that each of the chambers 106 is exposed to the gas from the inflation nozzle to fully inflate the chambers 106.

In some embodiments, it would be advantageous for the web material 100 to have a cross-sectional shape other than the folded configuration shown in FIG. 10 and the V-shaped configuration shown in FIG. 2A. Depicted in FIG. 2B is an embodiment of the web material 100 having a U-shaped cross-section. In some embodiments, the web material 100 has been held such that the longitudinal fold 114 has been unfolded and bends 122 and 124 have been formed in the web material 100. While a bend in the web material 100 may form a crease in the web material 100 to prevent the flow of gas through the chambers 106, the bends 122 and 124 are at angles that are sufficiently large to not pose a significant hinderance to the passage of gas through the chambers 106. For example, the path through the chambers 106 at each of the bends 122 and 124 forms an angle that is significantly less extreme than the angle of the path around the longitudinal fold 114 in FIG. 2A. In the depicted embodiment, the angles at each of the bends 122 and 124 are obtuse angles. A bend at an obtuse angle may allow sufficiently more gas to pass than a fold that has been somewhat opened to an acute angle. With the bends 122 and 124 in the web material 100, gas inserted into the chambers 106 by an inflation nozzle passes toward the bend 122, around the bend 122, around the bend 124, and then continues to the distal ends 110.

In addition to difficulty ensuring proper inflation with using the web material 100, the web material 100 may also be difficult to properly convey automatically. One example of difficulty in conveying the web material 100 is depicted in FIGS. 2C and 2D. In FIG. 2C, the web material 100 is conveyed by rollers 140 and rollers 142. The rollers 140 are a pair of counterrotating nip rollers through which a portion of the web material 100 near the second longitudinal edge 104 passes. The rollers 142 are a pair of counterrotating nip rollers through which a portion of the web material 100 near the first longitudinal edge 102 passes. At the instance shown in FIG. 2C, the rollers 140 and the rollers 142 are holding the web material 100 such that the first and second longitudinal edges 102 and 104 are substantially level at a horizontal plane 144.

It may be advantageous for the web material 100 to be held and conveyed while the first and second longitudinal edges 102 and 104 remain substantially level at the horizontal plane 144 while the web material 100 is held and conveyed by the rollers 140 and the rollers 142. However, as the web material 100 is conveyed by the rollers 140 and the rollers 142, the web material 100 may slide out of position with respect to the rollers 140 and the rollers 142. In FIG. 2D, the web material 100 has slid so that the first longitudinal edge 102 is located above the horizontal plane 144 and the second longitudinal edge 104 is located below the horizontal plane 144. This positioning of the web material 100 may affect further conveying of the web material 100, inflation of the chambers 106 in the web material 100, or any other aspect of handling the web material 100 (e.g., forming transverse seals in the web material 100). In addition, the web material 100 can continue to slide from the position shown in FIG. 2D until the second longitudinal edge 104 is no longer located between the rollers 140 and/or the first longitudinal edge 102 is no longer located between the rollers 142. It would be advantageous for an automated packaging station to hold a web material in way that keeps longitudinal edges of the material web substantially level.

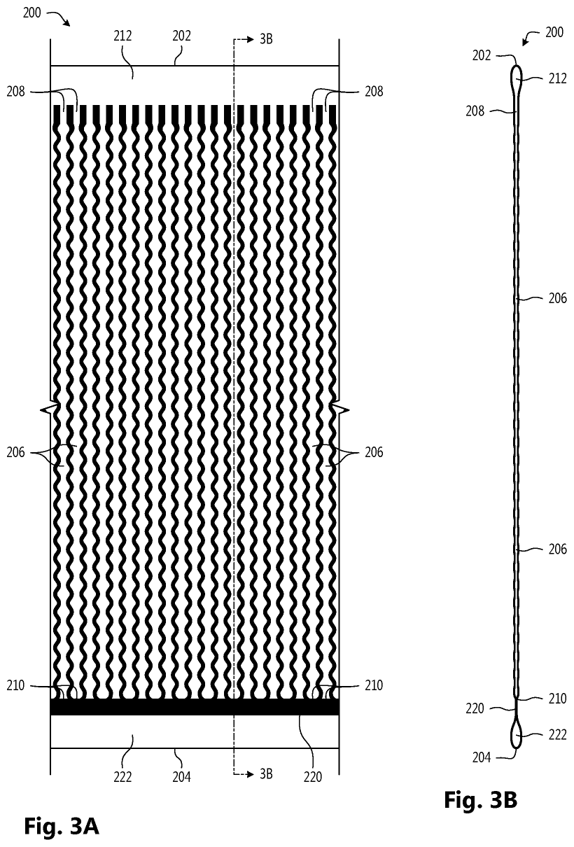

Depicted in FIGS. 3A and 3B are front and cross-sectional side views, respectively, of a web material 200 in an unfolded state. The web material 200 includes a first longitudinal edge 202 and a second longitudinal edge 204. Between the first and second longitudinal edges 202 and 204 are two juxtaposed sheets (e.g., sheets of film) that are sealed together to form chambers 206. In the depicted embodiment, the chambers 206 are in an uninflated state and the chambers 206 are capable of being inflated. In the depicted embodiment, each of the chambers 206 extends substantially transversely across the web material 200 and the pattern of the chambers 206 generally repeats in the longitudinal direction.

In the depicted embodiment, each of the chambers 206 includes a port 208 that is open and a distal end 210 that is closed. The ports 208 are located proximate the first longitudinal edge 202 and the distal ends 210 are located proximate the second longitudinal edge 204 so that the ports 208 and the distal ends 210 extend substantially transversely across the web material 200. The juxtaposed sheets are sealed between the ports 208 and the distal ends 210 such that each of the chambers 206 has substantially circular cells that are interconnected by channels that are narrower than the widest point of the cells. The chambers 206 are capable of being inflated by inserting a gas (e.g., air) through the ports 208. Once the chambers 206 are inflated, the cells form three-dimensional shapes (sometimes referred to as “bubbles”) along the inflated chambers 206. In the depicted embodiment, a pair of adjacent chambers 206 are offset so that the cells of one of the chambers 206 are aligned with the interconnecting channels of a subsequent one of the chambers 206.

The web material includes a first channel 212 and a second channel 222. The first channel 212 is located proximate the first longitudinal edge 202 and the second channel 222 is located proximate the second longitudinal edge 204. In the depicted embodiment, each of the first and second channels 212 and 222 is a “closed” channel because the two sides of the first channel 212 are connected at the first longitudinal edge 202 and the two sides of the second channel 222 are connected at the second longitudinal edge 204. In this way, the first channel 212 forms a loop above the ports 208 and the second channel 222 forms a loop below the distal ends 210. In other embodiments, one or both of the first and second channels 212 and 222 can be an “open” channel where the two sides of the channel do not meet at the longitudinal edge.

In the depicted embodiment, the first channel 212 is in fluid communication with the chambers 206. In some embodiments, a nozzle can be inserted in the first channel 212 and direct a gas into the first channel 212. The gas inserted into the first channel 212 can pass through the ports 208 to inflate the chambers 206. In some embodiments, the nozzle may remain fixed while located within the first channel 212 and the web material 200 is moved longitudinally such that the nozzle sequentially inflates the chambers 206. Coupled to the nozzle may be a sealing device configured to close (e.g., seal closed) the ports 208 after inflation of the chambers 206. In the depicted embodiment, the second channel 222 is not in fluid communication with the chambers 206. A longitudinal seal 220 is located in the web material 200 between the distal ends 210 and the second channel 222. The longitudinal seal 220 deters any passage of gas between the chambers 206 and the second channel 222.

In some embodiments, the web material 200 can be folded and formed into a pouch for holding and cushioning an object. In some embodiments, the web material 200 can be folded, inflated, and transversely sealed to form an inflated pouch. An object can be inserted into the pouch and then the pouch can be closed to form a package around the object. In some embodiments, the web material 200 is formed from a material that is suitable for shipping the object. For example, the web material 200 may be opaque.

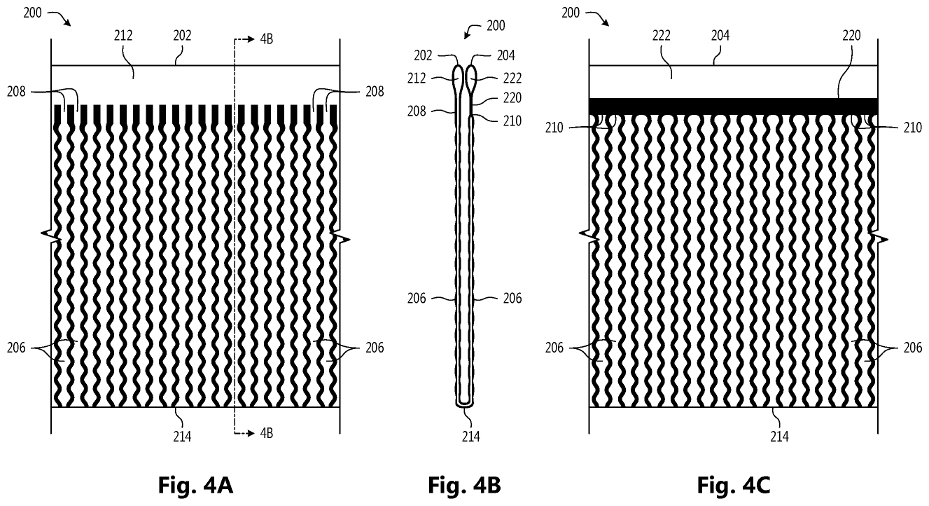

Depicted in FIGS. 4A, 4B, and 4C are front, cross-sectional side, and back views, respectively, of the web material 200 in a folded state before inflation of the chambers 206. A longitudinal fold 214 has been formed in the web material 200. In the depicted embodiment, the web material 200 is C-folded such that the longitudinal fold 214 substantially equidistant from the first and second longitudinal edges 202 and 204. Because the web material 200 is C-folded, the first and second channels 212 and 222 are located adjacent to each other. In other embodiments, the web material 200 is J-folded such that the longitudinal fold 214 is offset from the middle of the web material 200 between the first and second longitudinal edges 202 and 204.

From the folded state shown in FIGS. 4A to 4C, the web material 200 can be stored for later use by an automated packaging station. In some embodiments, the web material 200 can be wound around a cylindrical core initially to form a supply roll of the web material 200. The longitudinal fold 214 would be on one side of the supply roll and the first and second channels 212 and 222 would be on the other side of the supply roll. When wound into a supply roll, the web material 200 may be suitable for supplying an automated packaging station that can inflate and seal the web material 200 and then form the inflated web material 200 into a pouch for packaging an object. In other embodiments, the web material 200 in the folded state shown in FIGS. 4A to 4C can be stored in configurations other than a supply roll for later use by an automated packaging station.

In some embodiments, when the web material 200 is would into a supply roll, any gas (e.g., air) remaining in the channels 212 and 222 can cause winding difficulties. For example, the gas remaining in the channels 212 and 222 can become trapped, causing the web material 200 to be uneven across the supply roll. In some embodiments, the channels 212 and 222 can include perforations that permit gas trapped in the channels 212 and 222 to escape. Such perforations can be formed longitudinally in the channels 212 and 222. In some embodiments, the perforations can be continuous (e.g., perforations continuously through the longitudinal direction of the channel) or discontinuous (e.g., perforations applied periodically through the longitudinal direction of the channel). The perforations in the channels 212 and 222, whether continuous or discontinuous, can permit gas to escape the channels 212 and 222 so that gas does not become trapped in the channels 212 and 222 and trapped gas does not cause winding difficulties.

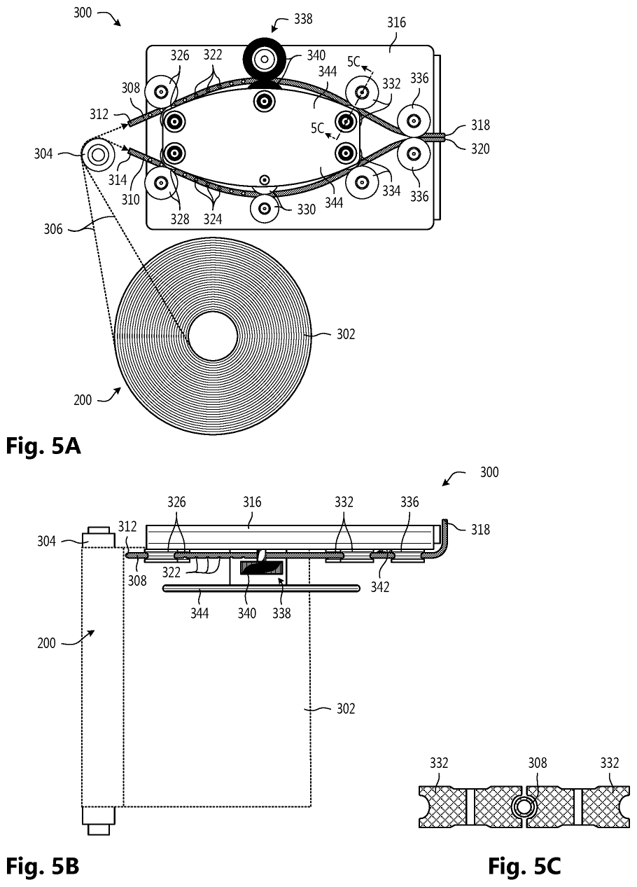

Depicted in FIGS. 5A and 5B are bottom and side views, respectively, of an embodiment of an automated packaging station 300 that uses the web material 200. The portion of the automated packaging station 300 depicted in FIGS. 5A and 5B may be merely a portion of the entire automated packaging station 300, such as a portion of any of the automated packaging stations shown in U.S. Patent Application No. 62/783,250, the contents of which are hereby incorporated by reference herein by reference in their entirety.

The automated packaging station 300 includes a supply 302 of the web material 200. In the depicted embodiment, the supply 302 is in the form of a roll with the web material 200 wound around a core. The supply 302 is arranged such that the axis of the roll is substantially vertical. In some embodiments, the web material 200 is arranged with respect to the axis of the supply 302 so that the longitudinal fold 214 of the web material 200 is on the lower (bottom) side of the supply 302 and the first and second channels 212 and 222 are on the upper (top) side of the supply 302. While on the supply 302, the chambers 206 of the web material 200 are in a non-inflated state such that the web material 200 is in a “flat” condition on the supply 302 and can be wound tightly on the roll. In some embodiments, the supply 302 is located on a substantially vertical spindle that is configured to rotate freely such that the web material 200 unwinds from the supply 302 as the web material 200 is pulled from the supply 302. In other embodiments, the supply can be powered to actively unwind the web material 200 from the supply 302.

The automated packaging station 300 includes a positioning roller 304. As can be seen in FIG. 5A, the web material 200 can be fed from the supply 302 to the positioning roller 304. The web material 200 may pass from the supply 302 to the positioning roller 304 along a number of different paths 306, depending on the amount of the web material 200 remaining the supply 302. The positioning roller 304 is arranged so that the web material 200 leaves the positioning roller 304 at substantially the same location regardless of which of the paths 306 that the web material 200 passes from the supply 302 to the positioning roller 304. In some embodiments, the positioning roller 304 is driven so that it rotates at times when the web material 200 is fed by the positioning roller 304. In other embodiments, the positioning roller 304 is an idle roller that rotates in response to contact from the web material 200 as the web material 200 is fed by the positioning roller 304.

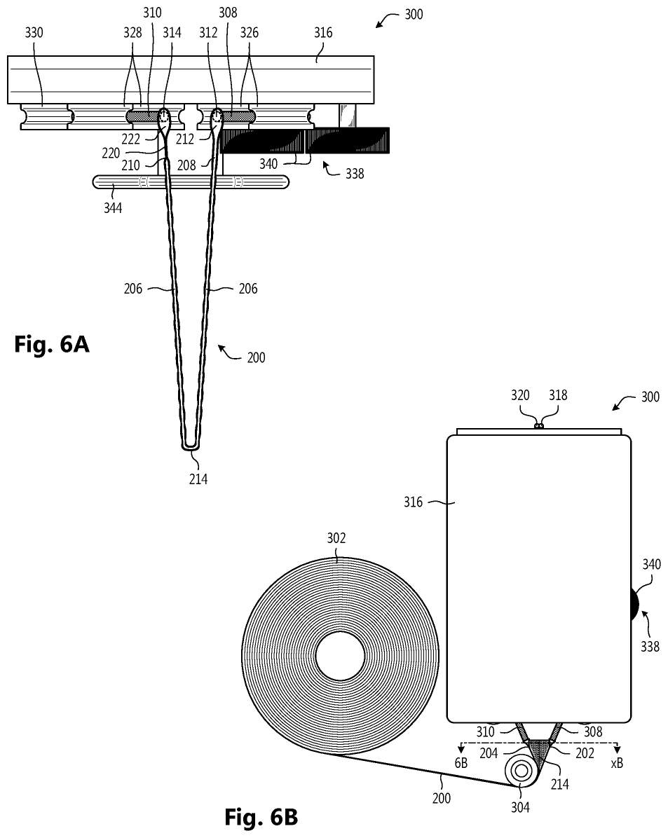

After the web material 200 leaves the positioning roller 304, the first and second longitudinal edges 202 and 204 are separated from each other. The automated packaging station 300 includes a first rail 308 and a second rail 310. The first longitudinal edge 202 of the web material 200 is fed toward a leading end 312 of the first rail 308 and the second longitudinal edge 202 of the web material 200 is fed toward a leading end 314 of the second rail 310. In the depicted embodiment, the leading ends 312 and 314 of the first and second rails 308 and 310 are cantilevered from a support structure 316 of the automated packaging station 300 so that the first channel 212 can be slid over the leading end 312 of the first rail 308 and the second channel 222 can be slid over the leading end 314 of the second rail 310. An example of how the first and second channels 212 and 222 are slid over the leading ends 312 and 314 of the first and second rails 308 and 310 are given below with respect to FIGS. 6A and 6B.

After the first and second channels 212 and 222 have been threaded through the first and second rails 308 and 310, the first and second rails 308 and 310 serve as a track for guiding the web material 200. In the depicted embodiment, the first and second rails 308 and 310 can also serve as nozzles for introducing gas into the first and second channels 212 and 222. In the depicted embodiment, each of the first and second rails 308 and 310 is a hollow tube and the leading ends 312 and 314 of the first and second rails 308 and 310 are closed. The first rail 308 has a trailing end 318 and the second rail 310 has a trailing end 320. Each of the trailing ends 318 and 320 can be coupled to a source of pressurized gas, such as a cylinder of pressurized gas, a gas compressor, and the like. The first rail 308 has outlets 322 and the second rail 310 has outlets 324. In some embodiments, the pressurized gas can be introduced into the first and second rails 308 and 310, proceed down the first and second rails 308 and 310, and then exit the first and second rails 308 and 310 through the outlets 322 and 324 into the first and second channels 212 and 222, respectively, of the web material 200. In this way, the outlets 322 form a nozzle that is integrated into the first rail 308 and the outlets 324 form a nozzle that is integrated into to the second rail 310.

The automated packaging station 300 also includes rollers that are capable of engaging the web material 200 to advance the web material 200. In the depicted embodiment, the automated packaging station 300 includes pairs of rollers 326, 328, 330, 332, 334, and 336 that are configured to drive the film. Each of the pairs of rollers 326, 328, 330, 332, 334, and 336 includes two rollers that have concave profiles so that the rollers can be placed around one or both of the first and second rails 308 and 310. An example of concave profiles of the set of rollers 332 around the first rail 308 is shown in a cross-sectional view depicted in FIG. 5C.

In the depicted embodiment, the automated packaging station 300 also includes a sealing system 338. The sealing system 338 includes rollers 340. As can be seen in FIG. 5B, the rollers 340 of the sealing system 338 are located below the first rail 308. The rollers 340 form a nip therebetween so that the web material 200 passes through the rollers 340. In some embodiments, the rollers 340 are positioned such that a portion of the web material 200 that includes the ports 208 of the chambers 206 passes between the rollers 340. In some embodiments, the rollers 340 are configured to form longitudinal seals in the web material 200 through the ports 208 to seal the chambers 206. In this way, the chambers 206 can be inflated by the gas that is inserted into the first channel 212 through the outlets 322 and the sealing system 338 can seal the chambers 206 closed in an inflated state. In some embodiments, one of the rollers 340 includes a circumferential heating element that contacts the web material 200 as it passes between the rollers 340 to form a heat seal in the web material 200. In other embodiments, the sealing system 338 may include drag sealers or any other form of sealer to form the longitudinal seals. In other embodiments, the ports 208 may include one-way seals that allow gas to enter the chambers 206 and holds the gas within the chambers 206 without the need of additional heat seals.

In the depicted embodiment, there are a number of the outlets 322 along the first rail 308 before the sealing system 338. Having a greater number of the outlets 322 can increase dwell time of each of the chambers 206 under one of the outlets 322 as the web material 200 is fed along the first rail 308. However, it will be understood that the outlets 322 could include a single outlet or a plurality of outlets. In the depicted embodiment, the second rail 310 includes outlets 324 through which gas may be directed into the second channel 222. Because the second channel 222 is not in fluid communication with the chambers 206, the gas that passes into the second channel 222 will not inflate the chambers 206 in any way. However, inserting gas into the second channel 222 may cause the second channel 222 to have similar properties with respect to the second rail 310 (e.g., a coefficient of friction) that the first channel 212 has with respect to the first rail 308. In this way, both of the first and second channels 212 and 222 may “act” in similar ways as the web material 200 is being fed along the first and second rails 308 and 310.

As can be seen in FIG. 5A, the sets of rollers 326 and 328 are located along the first and second rails 308 and 310, respectively, at similar locations in the downstream direction (i.e., from left to right in the depiction shown in FIG. 5A). When arranged in this manner, as the web material 200 is being loaded onto the first and second rails 308 and 310, the rollers 326 and the rollers 328 are likely to engage the first channel 212 and the second channel 222, respectively, of the web material 200 at close to the same time. In addition, as the rollers 326 and 328 drive the web material 200, the forces imparted by the rollers 326 and 328 on the web material 200 may be substantially symmetrical so that the web material 200 is advanced without any twisting or torqueing of the web material 200. In the depicted embodiment, at least some of the outlets 322 are located in the first rail 308 upstream of the rollers 326 and at least some of the outlets 324 are located in the second rail 308 upstream of the rollers 328. This allows the first and second channels 212 and 222 to be at least partially inflated by the time they reach the rollers 326 and 328 so that the first and second channels 212 and 222 are more likely to contact and be driven properly by the rollers 326 and 328.

The rollers 340 in the sealing system 338 and the set of rollers 330 are located along the first and second rails 308 and 310, respectively, at similar locations in the downstream direction. When arranged in this manner, as the web material 200 is being loaded onto the first and second rails 308 and 310, the rollers 340 and the rollers 330 are likely to engage the first channel 212 and the second channel 222, respectively, of the web material 200 at close to the same time. In addition, as the rollers 340 and 330 drive the web material 200, the forces imparted by the rollers 340 and 330 on the web material 200 may be substantially symmetrical so that the web material 200 is advanced without any twisting or torqueing of the web material 200.

The sets of rollers 332 and 334 are located along the first and second rails 308 and 310, respectively, at similar locations in the downstream direction. When arranged in this manner, as the web material 200 is being loaded onto the first and second rails 308 and 310, the rollers 332 and the rollers 334 are likely to engage the first channel 212 and the second channel 222, respectively, of the web material 200 at close to the same time. In addition, as the rollers 332 and 334 drive the web material 200, the forces imparted by the rollers 332 and 334 on the web material 200 may be substantially symmetrical so that the web material 200 is advanced without any twisting or torqueing of the web material 200.

The rollers 336 are located on either side of the first and second rails 308 and 310 at a location where the first and second rails 308 and 310 come together. This arrangement brings the first and second channels 212 and 222 back into proximity with each other so that both of the first and second channels 212 and 222 pass between the rollers 336. As the rollers 336 drive the web material 200, the forces imparted by the rollers 336 on the web material 200 may be substantially symmetrical so that the web material 200 is advanced without any twisting or torqueing of the web material 200.

In some embodiments, the automated packaging station 300 include a cutting element 342 located above the first rail 308. In the embodiment visible in FIG. 5B, the cutting element 342 is an angled blade positioned above the first rail 308. The cutting element 342 is positioned so that the cutting element 342 cuts the first channel 212. After the first channel 212 has been cut, the first channel 212 can be fed off of the first rail 308. In some embodiments, the cutting element is located along the first rail 308 between the sealing system 338 and the point at which the first and second rails 308 and 310 come together. This positioning allows the first channel to be removed from the first rail 308 before the first rail 308 comes into contact with the second rail 310. While not visible in FIG. 5B, another cutting element can be located on the second rail 310 and provide the same function with respect to the second channel 222 as the cutting element 342 provides with respect to the first channel 212.

One benefit of the use of the first and second rails 308 and 310 in the automated packaging station 300 is that the shape of the first and second rails 308 and 310 can cause the first and second longitudinal edges 202 and 204 of the web material 200 to diverge before and/or during inflation of the chambers 206. For example, in the downstream direction, the first and second rails 308 and 310 diverge over the range where the outlets 322 and 324 are located. This divergence of the first and second rails 308 and 310 increases the likelihood that the longitudinal fold 214 will unfold sufficiently to permit inflation of the entirety of the chambers 206. For example, the divergence of the first and second rails 308 and 310 can cause the web material to transition from having a V-shaped cross-section (e.g., a cross-section similar to the one depicted in FIG. 2A) to having a U-shaped cross-section (e.g., a cross-section similar to the one depicted in FIG. 2B).

In the depicted embodiment, the automated packaging station 300 also includes a guide 344 that can increase the likelihood that the chambers 206 will properly inflate. The guide 344 is in the form of a static guide that is located below the rollers and is configured to contact portions of the web material 200 below the first channel 212 and the second channel 222. The position and shape of the guide 344 may further encourage the longitudinal fold 214 will unfold sufficiently to permit inflation of the entirety of the chambers 206. In embodiments where the guide 344 contacts portions of the web material 200 below the first channel 212 and the second channel 222, the guide 344 may have more of a biasing effect on the web material 200 that encourages unfolding of the longitudinal fold 214. In the depicted embodiment, the longitudinal sides of the guide 344 have a shape similar to the shape of the first and second rails 308 and 310.

Depicted in FIGS. 6A and 6B are front and top views, respectively, of an example of loading the web material 200 on the first and second rails 308 and 310 of the automated packaging station 300. At the depicted instance, a portion of the web material 200 has been withdrawn from the supply 302 and routed around the positioning roller 304. The leading end of the web material 200 has been brought up to the leading ends 312 and 314 of the first and second rails 308 and 310. More specifically, the leading end of the first channel 212 has been aligned with the leading end 312 of the first rail 308 and the leading end of the second channel 222 has been aligned with the leading end 314 of the second rail 310. This positioning of the web material 200 can be done manually, such as in the case of a user pulling the web material 200 from the supply 302 and aligning the first and second channels 212 and 222 with the leading ends 312 and 314 of the first and second rails 308, or automatically, such as in the case of components of the automated packaging station 300 withdrawing the web material 200 from the supply 302 and aligning the first and second channels 212 and 222 with the leading ends 312 and 314 of the first and second rails 308.

From the point depicted in FIGS. 6A and 6B, the first channel 212 can be slid over the leading end 312 of the first rail 308 and the second channel 222 can be slid over the leading end 314 of the second rail 310. The web material 200 can be advanced, either manually or automatically, until the first channel 212 makes contact with and is driven by the rollers 326 and the second channel 222 makes contact with and is driven by the rollers 328. At that point, the rollers 326 and 328 can be driven to advance the web material 200. The first and second rails 308 and 310 guide the first and second channels 212 and 222, respectively, as the web material 200 is advanced until the first channel 212 makes contact with and is driven by the rollers 340 and the second channel 222 makes contact with and is driven by the rollers 330. In the depicted embodiment, the first and second rails 308 and 310 are arranged to position the web material 200 such that, when the web material 200 reaches the rollers 330 and 340, portions of the web material 200 pass between the rollers 330 and between the rollers 340 without the need for manual positioning of the web material 200.

Once a portion of the web material 200 is located between the rollers 330 and 340, the rollers 330 and 340 can be driven to advance the web material 200. The first and second rails 308 and 310 guide the first and second channels 212 and 222, respectively, as the web material 200 is advanced until the first channel 212 makes contact with and is driven by the rollers 332 and the second channel 222 makes contact with and is driven by the rollers 334. In the depicted embodiment, the first and second rails 308 and 310 are arranged to position the web material 200 such that, when the web material 200 reaches the rollers 332 and 334, portions of the web material 200 pass between the rollers 332 and between the rollers 334 without the need for manual positioning of the web material 200.

Once a portion of the web material 200 is located between the rollers 332 and 334, the rollers 332 and 334 can be driven to advance the web material 200. The first and second rails 308 and 310 guide the first and second channels 212 and 222, respectively, as the web material 200 is advanced until the first channel 212 is cut open by the cutting element 342 and the second channel 222 is cut open by a cutting element. After the first and second channels 212 and 222 are cut open, portions of the first and second channels 212 and 222 pass between the rollers 336. In some embodiments, when the web material 200 reaches the rollers 332 and 334, portions of the web material 200 pass between the rollers 336 without the need for manual positioning of the web material 200.

As can be seen from the preceding example of loading the web material 200 on the automated packaging station 300, the amount of user action required to load the web material 200 on the automated packaging station is relatively low. When manually loading the web material on the automated packaging station 300, the user can pull a portion of the web material 200 from the supply 302, route the web material 200 around the positioning roller 304, slide the first channel 212 onto the first rail 308, slide the second channel 222 onto the second rail 310, and bring the first and second channels into contact with the roller 326 and 328, respectively. From that point, the automated packaging station 300 guides and routes the web material 200 along the first and second rails 308 and 310 while inflating and sealing the chambers 206.

In the embodiment of the web material 200, the first channel 212 is in fluid communication with the chambers 206 and the second channel 222 is not in fluid communication with the chambers 206. The sealing system 338 of the automated packaging station 300 is located as the side of the web material 200 with the first channel 212 and the ports 208 will pass. In other embodiments, a web material can include two channels that are in fluid communication with inflatable chambers.

In some embodiments, the sizes of the channels 212 and 222 can have an effect on the threading of the channels 212 and 222 onto the first and second rails 308 and 310 and on the inflatability of the chambers 206. For example, narrow channels are difficult to open and difficult to thread onto rails. Wide channels may be easier to thread onto rails. However, wide channels create higher hoop stress, which can cause the channels to rupture during inflation. Also, wide channels can trap gas more easily, which can cause winding difficulties when the web material is wound onto a supply roll. In some embodiments, a channel having a size between about 0.5 inches (1.27 cm) and about 1.1 inches (2.79 cm)—as measured when the web material is flat—balances the effect of hoop stress and chamber inflation rate with the ability to open and thread the channels onto rails.

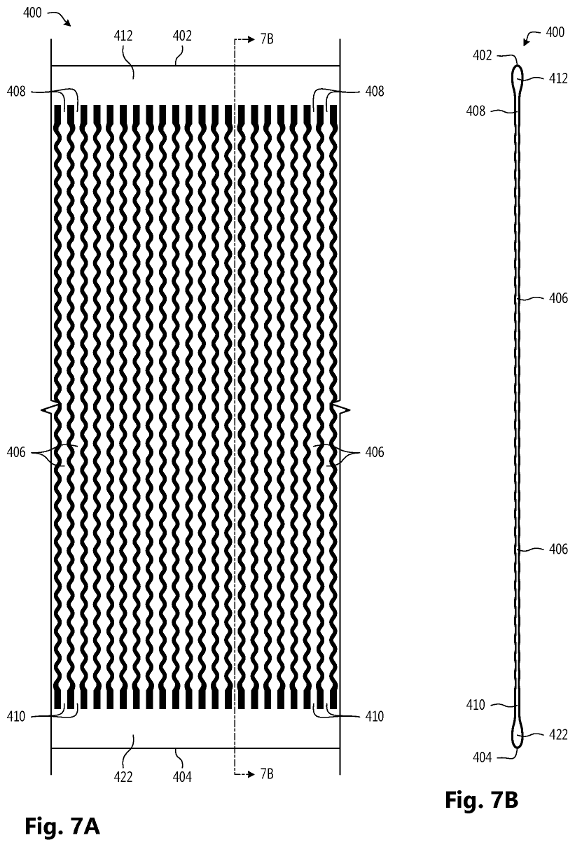

Depicted in FIGS. 7A and 7B are front and cross-sectional side views, respectively, of a web material 400 in an unfolded state. The web material 400 includes a first longitudinal edge 402 and a second longitudinal edge 404. Between the first and second longitudinal edges 402 and 404 are two juxtaposed sheets (e.g., sheets of film) that are sealed together to form chambers 406. In the depicted embodiment, the chambers 406 are in an uninflated state and the chambers 406 are capable of being inflated. In the depicted embodiment, each of the chambers 406 extends substantially transversely across the web material 400 and the pattern of the chambers 406 generally repeats in the longitudinal direction.

In the depicted embodiment, each of the chambers 406 includes a first port 408 and a second port 410, both of which are open. The first ports 408 are located proximate the first longitudinal edge 402 and the second ports 410 are located proximate the second longitudinal edge 404 so that the chambers 406 extend substantially transversely across the web material 400. The juxtaposed sheets are sealed between the first ports 408 and the second ports 410 such that each of the chambers 406 has substantially circular cells that are interconnected by channels that are narrower than the widest point of the cells. The chambers 406 are capable of being inflated by inserting a gas (e.g., air) through the first ports 408 and/or the second ports 410. Once the chambers 406 are inflated, the cells form three-dimensional shapes (sometimes referred to as “bubbles”) along the inflated chambers 406. In the depicted embodiment, a pair of adjacent chambers 406 are offset so that the cells of one of the chambers 406 are aligned with the interconnecting channels of a subsequent one of the chambers 406.

The web material includes a first channel 412 and a second channel 422. The first channel 412 is located proximate the first longitudinal edge 402 and the second channel 422 is located proximate the second longitudinal edge 404. In the depicted embodiment, each of the first and second channels 412 and 422 is a “closed” channel because the two sides of the first channel 412 are connected at the first longitudinal edge 402 and the two sides of the second channel 422 are connected at the second longitudinal edge 404. In this way, the first channel 412 forms a loop above the first ports 408 and the second channel 422 forms a loop below the second ports 410. In other embodiments, one or both of the first and second channels 412 and 422 can be an “open” channel where the two sides of the channel do not meet at the longitudinal edge.

In the depicted embodiment, each of the first channel 412 and the second channel 422 is in fluid communication with the chambers 406. In some embodiments, one or more nozzles can be inserted in the first channel 412 and/or the second channel 422 to direct a gas into the first channel 412 and/or the second channel 422. The gas inserted into the first channel 412 and/or the second channel 422 can pass through the first ports 408 and/or the second ports 410 to inflate the chambers 406. In some embodiments, the nozzle(s) may remain fixed while located within the first channel 412 and/or the second channel 422 and the web material 400 is moved longitudinally such that the nozzle(s) sequentially inflates the chambers 406. Coupled to each of the nozzle(s) may be one a sealing device configured to close (e.g., seal closed) the first ports 408 and/or the second ports 410 after inflation of the chambers 406.

In some embodiments, the web material 400 can be folded and formed into a pouch for holding and cushioning an object. In some embodiments, the web material 400 can be folded, inflated, and transversely sealed to form an inflated pouch. An object can be inserted into the pouch and then the pouch can be closed to form a package around the object. In some embodiments, the web material 400 is formed from a material that is suitable for shipping the object. For example, the web material 400 may be opaque.

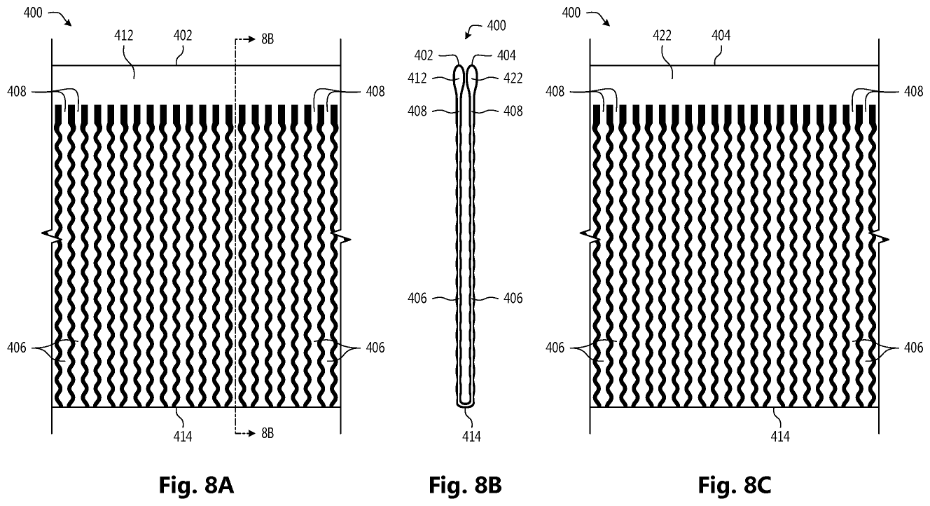

Depicted in FIGS. 8A, 8B, and 8C are front, cross-sectional side, and back views, respectively, of the web material 400 in a folded state before inflation of the chambers 406. A longitudinal fold 414 has been formed in the web material 400. In the depicted embodiment, the web material 400 is C-folded such that the longitudinal fold 414 substantially equidistant from the first and second longitudinal edges 402 and 404. Because the web material 400 is C-folded, the first and second channels 412 and 422 are located adjacent to each other. In other embodiments, the web material 400 is J-folded such that the longitudinal fold 414 is offset from the middle of the web material 400 between the first and second longitudinal edges 402 and 404.

From the folded state shown in FIGS. 8A to 8C, the web material 400 can be stored for later use by an automated packaging station. In some embodiments, the web material 400 can be wound around a cylindrical core initially to form a supply roll of the web material 400. The longitudinal fold 414 would be on one side of the supply roll and the first and second channels 412 and 422 would be on the other side of the supply roll. When wound into a supply roll, the web material 400 may be suitable for supplying an automated packaging station that can inflate and seal the web material 400 and then form the inflated web material 400 into a pouch for packaging an object. In other embodiments, the web material 400 in the folded state shown in FIGS. 8A to 8C can be stored in configurations other than a supply roll for later use by an automated packaging station.

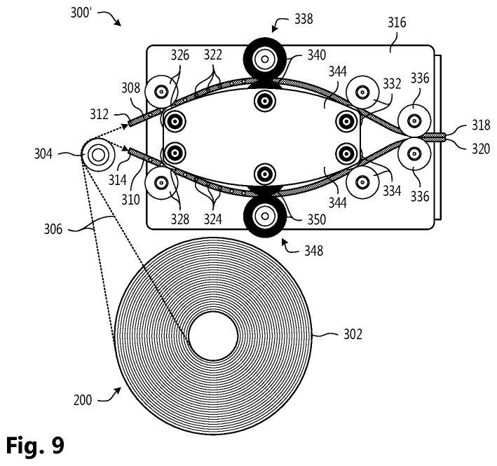

The portion of the automated packaging station 300′ depicted in FIG. 9 may be merely a portion of the entire automated packaging station 300′, such as a portion of any of the automated packaging stations shown in U.S. Patent Application No. 62/783,250, the contents of which are hereby incorporated by reference herein by reference in their entirety. The automated packaging station 300′ is similar to the automated packaging station 300 and includes many of the same components as the automated packaging station 300. A reference number that is used with respect to automated packaging station 300 and the automated packaging station 300′ indicates that the same component is included in both automated packaging station 300 and the automated packaging station 300′.

One difference between the automated packaging station 300′ and the automated packaging station 300 is that the automated packaging station 300′ does not include rollers 330. In place of the rollers 330 in the automated packaging station 300, the automated packaging station 300′ includes a sealing system 348. The sealing system 348 includes rollers 350. In some embodiments, the rollers 350 of the sealing system 348 are located below the second rail 310 at a similar height to the rollers 340 of the sealing system 338. The rollers 350 form a nip therebetween so that the web material 400 passes through the rollers 350. In some embodiments, the rollers 340 are positioned such that a portion of the web material 400 that includes the first ports 408 of the chambers 406 passes between the rollers 340 and the rollers 350 are positioned such that a portion of the web material 400 that includes the second ports 410 of the chambers 406 passes between the rollers 350. In some embodiments, the rollers 340 are configured to form longitudinal seals in the web material 400 through the first ports 408 and the rollers 350 are configured to form longitudinal seals in the web material 400 through the second ports 410 to seal the chambers 406. In this way, the chambers 406 can be inflated by the gas that is inserted into the first channel 412 through the outlets 322 and gas that is inserted into the second channel 422 through the outlets 324. The sealing system 338 and the sealing system 348 can seal the chambers 406 closed in an inflated state. In some embodiments, one of the rollers 350 includes a circumferential heating element that contacts the web material 400 as it passes between the rollers 350 to form a heat seal in the web material 400. In other embodiments, the sealing systems 338 and 348 may include drag sealers or any other form of sealer to form the longitudinal seals. In other embodiments, the first ports 408 and/or the second ports 410 may include one-way seals that allow gas to enter the chambers 406 and holds the gas within the chambers 406 without the need of additional heat seals.

The automated packaging station 300′ is capable of inflating and sealing the web material 400. The two sealing systems 338 and 348 are capable of sealing both ends of the chambers 406 after the chambers 406 are inflated. The automated packaging station 300′ is also capable of inflating and sealing the web material 200. The sealing system 338 is capable of sealing closed the chambers 206 after the chambers 206 are inflated. While the sealing system 348 of the automated packaging station 300′ may create an extraneous seal in the web material 200 (e.g., in the longitudinal seal 220), the automated packaging station 300′ will still seal closed the chambers 206 after the chambers 206 are inflated.

In a number of embodiments described herein, automated packaging stations include two guide rails. In other embodiments, automated packaging stations can also include a single guide rail. FIG. 10 depicts a bottom view of an embodiment of automated packaging station 500 that includes a single guide rail. The automated packaging station 500 includes some elements similar to the automated packaging station depicted in FIGS. 5A and 5B. Where elements of the automated packaging station 500 are similar to and/or the same as the elements of the automated packaging station 300, the same references numbers from the automated packaging station 300 are used.

After the web material 200 leaves the positioning roller 304, the first and second longitudinal edges 202 and 204 are separated from each other. The automated packaging station 300 includes a rail 510. The first longitudinal edge 202 of the web material 200 is fed toward a leading end 515 of the rail 510 and the second longitudinal edge 204 of the web material 200 is fed toward a side of the guide 344 opposite the rail 510. In the depicted embodiment, the leading end 514 of the rail 510 is cantilevered from the support structure 316 of the automated packaging station 300 so that the first channel 212 can be slid over the leading end 514 of the rail 510. The first channel 212 can be slid over the leading end 514 of the rail 510 similar to the way in which the first channel 212 is shown being slid over the leading end 312 of the first rail 308 of the automated packaging system 300 in FIGS. 6A and 6B.

After the first channel 212 has been threaded through the rail 510, the rail 510 serves as a track for guiding the first longitudinal edge 202 of the web material 200. The second longitudinal edge 204 of the web material 200 can be guided by the support structure 316. In the depicted embodiment, the rail 510 can also serve as a nozzle for introducing gas into the first channel 212. In the depicted embodiment, the rail 510 is a hollow tube and the leading end 514 of the rail 510 is closed. A distal end of the rail 510 is coupled to a manifold 520. The manifold 520 can be coupled to a source of pressurized gas, such as a cylinder of pressurized gas, a gas compressor, and the like. The rail 510 has outlets 524. In some embodiments, the pressurized gas can be introduced into the rail 510, proceed down the rail 510, and then exit the rail 510 through the outlets 524 into the first channel 212 of the web material 200. In this way, the outlets 524 form a nozzle that is integrated into to the rail 510.

The automated packaging station 300 also includes rollers that are capable of engaging the web material 200 to advance the web material 200. In the depicted embodiment, the automated packaging station 500 includes the pairs of rollers 336 that are configured to drive the web material 200. In the depicted embodiment, the automated packaging station 500 also includes a sealing system 538. The sealing system 538 includes rollers 540. In some embodiments, the rollers 540 of the sealing system 538 are located below the rail 508. The rollers 540 form a nip therebetween so that the web material 200 passes through the rollers 540. In some embodiments, the rollers 540 are positioned such that a portion of the web material 200 that includes the ports 208 of the chambers 206 passes between the rollers 540. In some embodiments, the rollers 540 are configured to form longitudinal seals in the web material 200 through the ports 208 to seal the chambers 206. In this way, the chambers 206 can be inflated by the gas that is inserted into the first channel 212 through the outlets 524 and the sealing system 538 can seal the chambers 206 closed in an inflated state. In some embodiments, one of the rollers 540 includes a circumferential heating element that contacts the web material 200 as it passes between the rollers 540 to form a heat seal in the web material 200. In other embodiments, the sealing system 538 may include a drag sealer or any other form of sealer to form the longitudinal seal. In other embodiments, the ports 208 may include one-way seals that allow gas to enter the chambers 206 and holds the gas within the chambers 206 without the need of additional heat seals.

In the depicted embodiment, there are a number of the outlets 324 along the rail 510 before the sealing system 538. Having a greater number of the outlets 524 can increase dwell time of each of the chambers 206 under one of the outlets 524 as the web material 200 is fed along the rail 508. However, it will be understood that the outlets 524 could include a single outlet or a plurality of outlets. Similarly, while the outlets 524 are depicted as circular openings in FIG. 10, the outlets 524 could have any other shape.

After the first channel 212 passes by the sealing system 538 and the chambers 206 are sealed closed by the sealing system 538, the web material 200 is advanced until the first channel 212 is cut open by the cutting element 342. After the first channel 212 is cut open, the first channel 212 can be fed off of the rail 510. In the depicted embodiment, the first channel 212 passes off of the rail and toward the rollers 336. The second channel 222 also passes from the side of the guide 344 opposite the rail 510 toward the rollers 336. This feeding of the first and second channels 212 and 222 brings the first and second channels 212 and 222 back into proximity with each other so that both of the first and second channels 212 and 222 pass between the rollers 336. As the rollers 336 drive the web material 200, the forces imparted by the rollers 336 on the web material 200 may be substantially symmetrical so that the web material 200 is advanced without any twisting or torqueing of the web material 200 as the web material 200 passes through the automated packaging station 500.

One benefit of the use of the rail 510 and the guide 344 in the automated packaging station 500 is that the shape of the rail 510 and the guide 344 can cause the first and second longitudinal edges 202 and 204 of the web material 200 to diverge before and/or during inflation of the chambers 206. For example, in the downstream direction, the rail 510 and the guide 344 diverge over the range where the outlets 524 are located. This divergence of the rail 510 and the guide 344 increases the likelihood that the longitudinal fold 214 will unfold sufficiently to permit inflation of the entirety of the chambers 206. For example, the divergence of the rail 510 and the guide 344 can cause the web material to transition from having a V-shaped cross-section (e.g., a cross-section similar to the one depicted in FIG. 2A) to having a U-shaped cross-section (e.g., a cross-section similar to the one depicted in FIG. 2B).

For purposes of this disclosure, terminology such as “upper,” “lower,” “vertical,” “horizontal,” “inwardly,” “outwardly,” “inner,” “outer,” “front,” “rear,” and the like, should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Unless stated otherwise, the terms “substantially,” “approximately,” and the like are used to mean within 5% of a target value.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

What is claimed is:

1. An automated packaging station configured to inflate and seal a web material, the automated packaging station comprising:
a first rail, wherein the web material includes a first channel, and wherein the first channel is closed so that the first channel can be slid over the first rail;
a first nozzle configured to insert gas into the first channel of the web material, wherein the first channel is in fluid communication with chambers of the web material so that the gas inserted into the first channel can pass into the chambers to inflate the chambers; and
a first sealing system configured to seal closed ends the chambers proximate the first channel after inflation of the chambers;
wherein a shape of the first rail is configured to cause the first channel and an opposite longitudinal side of the web material to diverge either before or during inflation of the chambers by the first nozzle.

2. The automated packaging station of claim 1, wherein the first nozzle includes one or more first outlets, and wherein the first rail is a hollow tube through which the gas passes before the gas passes through the one or more first outlets and into the first channel.

3. The automated packaging station of claim 2, wherein a leading end of the first rail is closed and a trailing end of the first rail is couplable to a source of pressurized gas.

4. The automated packaging station of claim 3, further comprising:
a second rail, wherein the web material includes a second channel, and wherein the second channel is closed so that the second channel can be slid over the second rail; and
a second nozzle configured to insert gas into the second channel of the web material;
wherein:
the second nozzle includes one or more second outlets,
the second rail is a hollow tube through which the gas passes before the gas passes through the one or more second outlets and into the second channel, and
a leading end of the second rail is closed and a trailing end of the second rail is couplable to the source of pressurized gas.

5. The automated packaging station of claim 1, further comprising:
a first roller configured to move the first channel along the first rail.

6. The automated packaging station of claim 5, wherein:
the first roller includes a first pair of rollers configured to be placed around the first rail.

7. The automated packaging station of claim 6, wherein each roller in the first pair of rollers has a concave profile around the first rail.

8. The automated packaging station of claim 1, wherein the opposite longitudinal side of the web material includes a longitudinal seal that closes the chambers.

9. The automated packaging station of claim 1, further comprising:
a second rail, wherein the opposite longitudinal side of the web material includes a second channel, and wherein the second channel is closed so that the second channel can be slid over the second rail.

10. The automated packaging station of claim 9, further comprising:
a second sealing system configured to seal closed ends of the chambers proximate the second channel after inflation of the chambers;
wherein, before the second sealing system seals closed the ends of the chambers proximate the second channel, the chambers are in fluid communication with the second channel.

11. The automated packaging station of claim 9, further comprising:
a guide located below the first and second rails, wherein the guide is configured to contact portions of the web material below the first channel and the second channel and to have a biasing effect on the web material that encourages unfolding of a longitudinal fold in the web material.

12. The automated packaging station of claim 11, wherein longitudinal sides of the guide have a shape similar to the shape of the first and second rails.

13. The automated packaging station of claim 9, further comprising:
a first cutting mechanism configured to cut the first channel downstream of a location where the first sealing system is configured to seal closed the ends of the chambers proximate the first channel; and
a second cutting mechanism configured to cut the second channel downstream of the location where the second sealing system is configured to seal closed the ends of the chambers proximate the second channel.

14. The automated packaging station of claim 9, further comprising:
a support structure;
wherein leading ends of the first and second rails are cantilevered from the support structure so that the first channel can be slid over a leading end of the first rail and the second channel can be slid over a leading end of the second rail.

15. The automated packaging station of claim 1, further comprising:
a cutting mechanism configured to cut the first channel downstream of a location where the first sealing system is configured to seal closed the ends of the chambers proximate the first channel.

16. A web material, comprising:
two juxtaposed sheets sealed together to form:
a first channel proximate a first longitudinal edge of the web material;
a second channel proximate a second longitudinal edge of the web material; and
chambers that extend substantially transversely across the web material between the first and second channels;
wherein the first channel is in fluid communication with the chambers; and
wherein the first and second channels are closed so that the first channel is configured to be slid onto a first rail of an automated packaging machine and the second channel is configured to be slid onto a second rail of the automated packaging machine.

17. The web material of claim 16, wherein the two juxtaposed sheets are also sealed together to form ports between the chambers and the first channel.

18. The web material of claim 16, wherein each of the chambers has cells that are substantially circular and are interconnected by interconnecting channels that are narrower than the widest point of the cells.

19. The web material of claim 18, wherein a pair of adjacent chambers are offset so that the cells of one of the chambers are aligned with the interconnecting channels of a subsequent one of the chambers.

20. The web material of claim 16, wherein the second channel is not in fluid communication with the chambers.

21. The web material of claim 16, wherein the two juxtaposed sheets are also sealed together to form a longitudinal seal between the chambers and the second channel.

22. The web material of claim 16, wherein the second channel is in fluid communication with the chambers.
